(19) United States
(12) Patent Application Publication
(10) Pub. No.: US 2009/0138299 A1
(43) Pub. Date: May 28, 2009

(54) METHOD FOR PROVIDING DYNAMIC PHONE ADVERTISEMENTS

(75) Inventors: Kulvir S. Bhogal, Fort Worth, TX (US); Travis M. Grisby, Austin, TX (US); Robert R. Peterson, Austin, TX (US); Lisa A. Seacat, San Francisco, CA (US)

Correspondence Address: Cantor Colburn LLP IBM SVL, 20 Church Street, 22nd Floor, Hartford, CT, 06103-3207, US

(73) Assignee: INTERNATIONAL BUSINESS MACHINES CORPORATION, Armond, NY (US)

(21) Appl. No.: 11/946,436

(22) Filed: Nov. 28, 2007

(51) Int. Cl. G06Q 30/00; G06F 17/30

(52) U.S. Cl. 705/7; 705/14

(57) ABSTRACT

A method of operating a communications service, including detecting that a user dials a phone number to initiate a current phone call, querying a dynamic advertising service which analyzes available data regarding the dialed phone number, receiving an advertisement from the dynamic advertising service that is selected based on the dialed phone number, the available data regarding the phone number and, optionally, other information, and playing the advertisement to the user.

### BACKGROUND OF THE INVENTION

1. Field of the Invention

Aspects of the present invention relate to a method of providing dynamic phone advertisements and, more particularly, to providing the dynamic phone advertisements to a user.

2. Description of the Background

Currently, there are several communications services in operation that allow advertisements to be distributed to users of communications services. These include services that operate by collecting information gleaned from users who have dialed certain numbers and by selling that information to advertising companies. Still other communications services operate by offering a user phone service for little or no monthly charges in return for the user agreeing to listen to advertisements.

However, where these communications services rely on selling advertising space, the advertisements themselves are often not customized or targeted. As such, the advertisements may be meaningless to the user and, therefore, less valuable. Thus, the services are generally incapable of maximizing advertising revenues.

### SUMMARY OF THE INVENTION

In accordance with an embodiment of the invention, a method of operating a communications service is provided and includes detecting that a user dials a phone number to initiate a current phone call, querying a dynamic advertising service which analyzes available data regarding the dialed phone number, receiving an advertisement from the dynamic advertising service that is selected based on the dialed phone number, the available data regarding the phone number and, optionally, other information, and playing the advertisement to the user.

Additional features and advantages are realized through the techniques of the present invention. Other embodiments and aspects of the invention are described in detail herein and are considered a part of the claimed invention. For a better understanding of the invention with advantages and features, refer to the description and of the drawings.

### DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 shows a schematic diagram of an operation of a communications service in accordance with an exemplary embodiment of the present invention;

FIG. 2 is a flow diagram of a method of operating a communications service in accordance with an embodiment of the present invention; and

FIG. 3 is a flow diagram of a method of operating a communications service in accordance with another embodiment of the present invention.

### DETAILED DESCRIPTION OF THE INVENTION

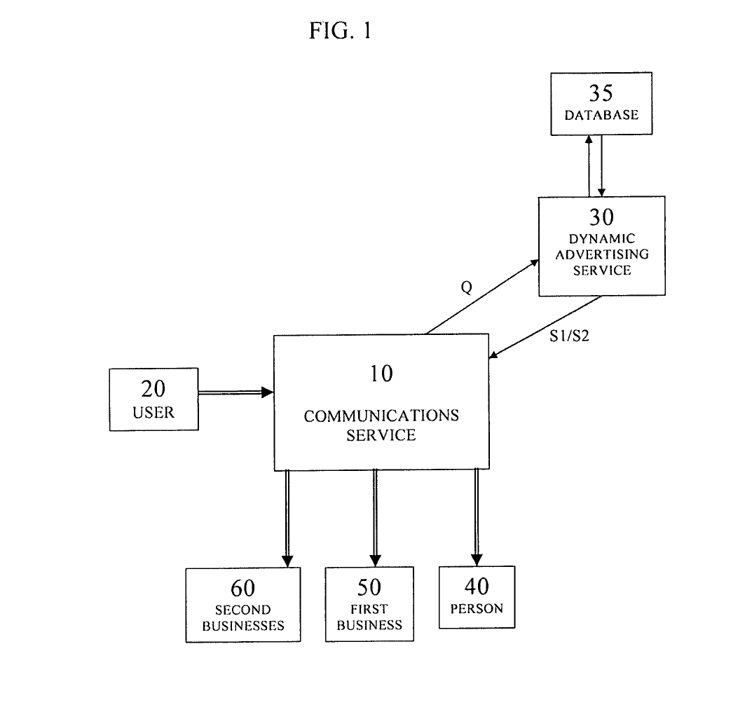

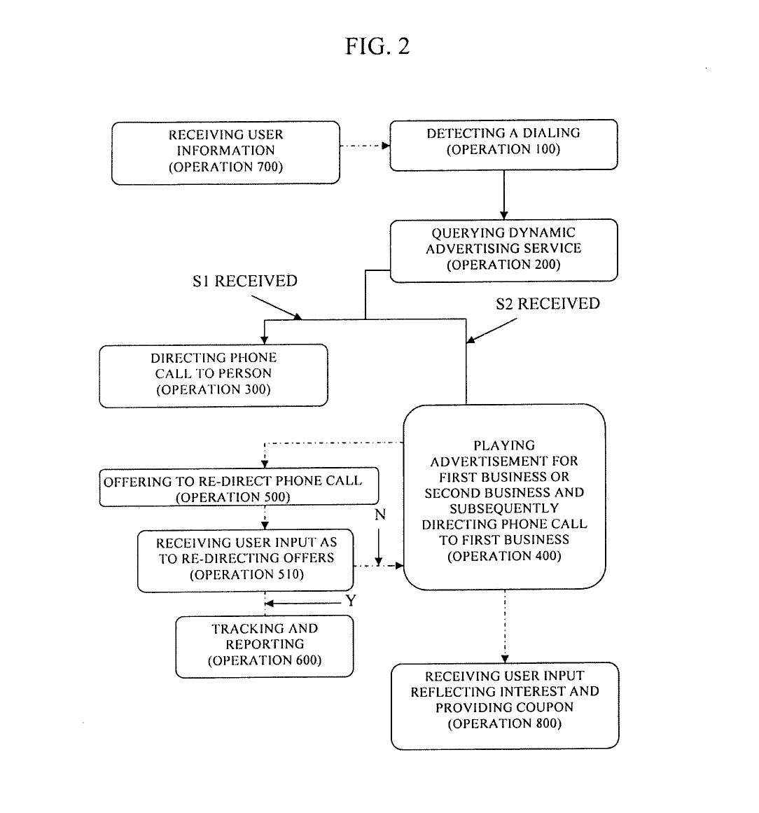

With reference to FIGS. 1 and 2, in accordance with an exemplary embodiment of the invention, a communications service 10 provides dynamic phone advertisements to a user 20 of the communications service 10. As shown in FIG. 1, in an embodiment of the invention, the communications service 10 detects that the user 20 dials a phone number to initiate a phone call. The communications service 10 then queries a dynamic advertising service 30 via query signal Q. Responsively, the dynamic advertising service 30 searches within a database 35 for data pertaining to the phone number dialed by the user 20.

Here, it is understood that the data being searched for may be any data providing information about an entity associated with the phone number. In an embodiment of the invention, the data being searched for may be a name of a business associated with the phone number, if the phone number is actually a business phone number. It is further understood that other items of data that identify a business could be used to the same or a similar effect.

Responsive to the query signal Q, in accordance with a further embodiment of the invention, if the data being searched for is a name of a business and is not found by the dynamic advertising service 30, the dynamic advertising service 30 determines that the data does not exist and that the phone call is a personal phone call. Subsequent to this determination, the dynamic advertising service 30 issues a first signal S1 indicating that an entity associated with the phone number is a person 40. If, however, the dynamic advertising service 30 finds the data, the dynamic advertising service determines that the data exists and that the phone call is a business related phone call. The dynamic advertising service 30 then issues a second signal S2 indicating that the entity associated with the phone number is a first business 50. In addition, the second signal S2 may include an advertisement for the first business 50 or one of a set of second businesses 60, which is unrelated to, supportive of and/or competitive with the first business 50 and which is selected based on the data.

In accordance with an embodiment of the invention, the second signal S2 may further include a discounted offer from the first business or one of the set of second businesses 60.

Here, it is understood that even if a determination is made that the phone call is personal, the first signal S1 may, in accordance with an embodiment of the invention, also include an advertisement. However, such an advertisement will be precisely targeted as will be discussed below.

Upon receipt of the first signal S1, the communications service 10 directs the phone call to the person 40 or, in accordance with the embodiment in which the first signal S1 includes an advertisement, the communications service 10 plays the advertisement to the user 10 and, subsequently, directs the phone call to the person 40. Conversely, upon receipt of the second signal S2, the communications service 10 plays the advertisement of the one of the second businesses 60 for the user 10 and, subsequently, directs the phone call to the first business 50.

With reference to FIG. 2, as noted above, the method comprises detecting that the user dials a phone number to initiate a phone call (operation 100) and querying the dynamic advertising service 30 (operation 200), which searches for the data pertaining to the phone number and either issues the first or the second signal S1 or S2. Next, upon receipt of the first signal, the method further comprises either directing the phone call to the person 40 (operation 300) or, upon receipt of the second signal, playing the advertisement of the one of the second businesses 60 for the user and, subsequently, directing the phone call to the first business 50 or the one of the second businesses 60 (operation 400).

Still referring to FIG. 2, in accordance with additional embodiments of the invention, subsequent to the playing of the advertisement and before the directing of the phone call to the first business 50, the method may further comprise offering to direct the phone call to the one of the second businesses 60 and/or offering to direct a subsequent phone call to the one of the second businesses 60 at the completion of the phone call (operation 500). Here, the method comprises receiving a user input indicating a preference as to the directing of the phone call and operating accordingly (operation 510).

Additionally, the method may further comprise tracking user preferences and reporting the user preferences (operation 600). Here, the tracking may include tracking a first number of times advertisements of each of the set of second businesses 60 are played to the user and a second number of times either of the directing offers are accepted. The reporting may include reporting the first and second numbers of times to each of the corresponding second businesses 60.

Still referring to FIG. 2, in accordance with other embodiments of the invention, the method may further comprise initially receiving user specific information from the user (operation 700) where such user specific information is available. Here, the communications service 10 transfers the user specific information to the dynamic advertising service 30 during the querying operation 200. The dynamic advertising service 30 then tailors the search for data in accordance with the user specific information. For example, if the user specific information represents a business/personal contact list of the user, the dynamic advertising service 30 searches the contact list to determine if the business/person the dialed phone number belongs to is categorized as being within a user defined group. If the group is defined as a “family” group, the dynamic advertising service 30 serves a family targeted advertisement (i.e., a children's movie). Conversely, if the group is defined as a “restaurant” group, the dynamic advertising service 30 serves an advertisement of a restaurant located near the user.

The method may further comprise receiving a user input reflecting a level of interest in the one of the second businesses 60 and providing the user with a coupon associated with the first business 50 or the one of the second businesses 60 (operation 800) via regular or electronic mail.

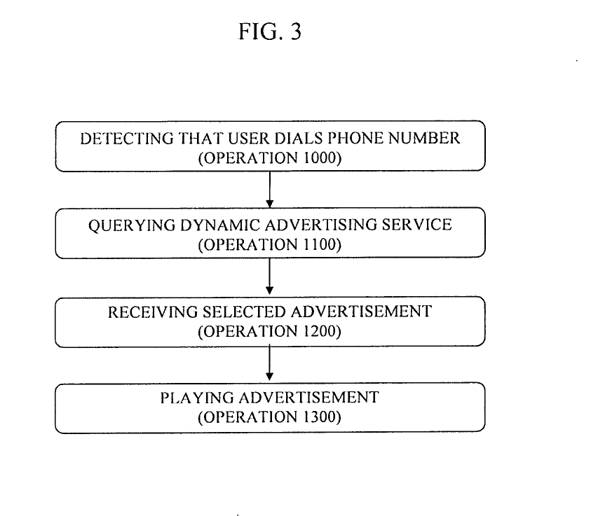

With reference to FIG. 3 and in accordance with another embodiment of the invention, a method of operating a communications service may include detecting that a user dials a phone number to initiate a current phone call (operation 1000), querying a dynamic advertising service which analyzes available data regarding the dialed phone number (operation 1100), receiving an advertisement from the dynamic advertising service that is selected based on the dialed phone number, the available data regarding the phone number and, optionally, other information (operation 1200), and playing the advertisement to the user (operation 1300).

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A method of operating a communications service, comprising:
detecting that a user dials a phone number to initiate a current phone call;
querying a dynamic advertising service which analyzes available data regarding the dialed phone number;
receiving an advertisement from the dynamic advertising service that is selected based on the dialed phone number, the available data regarding the phone number and, optionally, other information; and
playing the advertisement to the user.

2. The method according to claim 1, wherein, if a target of the dialed phone number is a first business and the advertisement is related to one of a set of second businesses, subsequent to the playing of the advertisement and before the directing of the phone call to the first business, the method further comprises:
offering to direct the current phone call to the one of the second businesses;
offering to direct a subsequent phone call to the one of the second businesses at the completion of the current phone call;
receiving a user input indicating a preference as to the directing of the current phone call; and
operating in accordance with the user input, and wherein the method further comprises:
tracking:
a first number of times that advertisements for each of the set of second businesses are played to the user, and
a second number of times that the offers to direct the phone call or the subsequent phone call to each of the set of second businesses are accepted; and
reporting the first and second numbers of times to each of the corresponding second businesses.

3. The method according to claim 1, further comprising receiving user specific information from the user, wherein the dynamic advertising service tailors a search for the available data regarding the dialed phone number in accordance with the user specific information.

4. The method according to claim 1, further comprising:
receiving a user input reflecting a level of interest in an entity to which the advertisement relates, and
providing the user with a coupon associated with the entity.
